(19) United States
(12) Patent Application Publication
(10) Pub. No.: US 2023/0026416 A1
(43) Pub. Date: Jan. 26, 2023

(54) SKIN COLOR CHART AND METHOD FOR MANUFACTURING THE SAME

(71) Applicant: NEC Corporation, Minato-ku, Tokyo (JP)

(72) Inventor: Chisato FUNAYAMA, Tokyo (JP)

(73) Assignee: NEC Corporation, Minato-ku, Tokyo (JP)

(21) Appl. No.: 17/777,660

(22) PCT Filed: Nov. 29, 2019
(86) PCT No.: PCT/JP2019/046773

§ 371 Date: May 18, 2022

(51) Int. Cl. G09F 5/04

(52) U.S. Cl. CPC G09F 5/04; G06V 40/162

(57) ABSTRACT

A skin color chart (10) according to an example aspect of the present disclosure includes: a substrate (11); a first skin color display part (BK) configured to show a skin color of a Negroid, the first skin color display part being formed on the substrate (11); and a second skin color display part (WT) configured to show a skin color of a Caucasoid, the second skin color display part being formed on the substrate (11). Lightness L* of the first skin color display part (BK) in a CIE L*a*b* color space satisfies 20≤L*≤37, and lightness L* of the second skin color display part (WT) in the CIE L*a*b* color space satisfies 74≤L*≤81.

### TECHNICAL FIELD

The present disclosure relates to a skin color chart and a method for manufacturing the same.

### BACKGROUND ART

In recent years, a face authentication system that specifies a person by using a face image of the person captured by a camera has been developed. Note that, in the face image of a person with white skin such as Caucasoid, blown-out highlights tend to occur in a bright environment, and in the face image of a person with black skin such as Negroid, blocked-up shadows tend to occur in a dark environment.

When such blown-out highlights or blocked-up shadows occur in the face image, face authentication may not be performed accurately. Therefore, for example, when a camera for a face authentication system is installed, it is necessary to determine whether or not the environment for performing face authentication (hereinafter referred to as a face authentication environment) is appropriate. The face authentication environment varies depending on, for example, the position where a camera is installed, the orientation of the camera, and the brightness of a place where a face image is captured.

Incidentally, Patent Literature 1 discloses a skin color chart for evaluating skin color reproduction in a color photograph or the like.

Note that, in this specification, the terms “Negroid”, “Caucasoid”, and “Mongoloid” are used in order to describe differences in skin color; however, the use of these terms is not intended to discriminate against any race.

### CITATION LIST

### Patent Literature

### Patent Literature 1: Japanese Unexamined Patent Application Publication No. 2001-074556

### SUMMARY

### Technical Problem

The inventor has found the following problem as a result of examining a case where a skin color chart is captured by a camera and then a face authentication environment is determined using the acquired image of the skin color chart.

As described above, the skin color chart disclosed in Patent Literature 1 is used for evaluating skin color reproduction in a color photograph or the like, and includes an average Caucasoid skin color display part and an average Negroid skin color display part. When the face authentication environment is determined using this skin color chart, it is determined that the environment is suitable for face authentication, for example, if no blown-out highlights occur in the Caucasoid skin color display part and no blocked-up shadows occur in the Negroid skin color display part in the acquired image of the skin color chart.

However, even in the environment which it has been determined using the skin color chart disclosed in Patent Literature 1 is suitable for face authentication, face authentication may not be performed accurately. Specifically, even in the environment which it has been determined is suitable for face authentication, the environment may actually be too dark and blocked-up shadows may occur in the face image of a person whose skin is blacker than the average Negroid skin color display part in the skin color chart. Conversely, the environment may actually be too bright and blown-out highlights may occur in the face image of a person whose skin is whiter than the average Caucasoid skin color display part in the skin color chart.

In view of the problem described above, an object of the present disclosure is to provide a skin color chart that enables a more appropriate determination of a face authentication environment and a method for manufacturing the same.

### Solution to Problem

A skin color chart according to the present disclosure is a skin color chart for determining an environment where face authentication is performed, the skin color chart including:

a substrate;

a first skin color display part configured to show a skin color of a Negroid, the first skin color display part being formed on the substrate; and

a second skin color display part configured to show a skin color of a Caucasoid, the second skin color display part being formed on the substrate, in which

lightness L* of the first skin color display part in a CIE L*a*b* color space satisfies 20≤L*≤37, and

lightness L* of the second skin color display part in the CIE L*a*b* color space satisfies 74≤L*≤81.

A method for manufacturing a skin color chart according to the present disclosure is a method for manufacturing a skin color chart for determining an environment where face authentication is performed, the method including:

forming, on a substrate, a first skin color display part configured to show a skin color of a Negroid; and

forming, on the substrate, a second skin color display part configured to show a skin color of a Caucasoid, in which

lightness L* of the first skin color display part in a CIE L*a*b* color space satisfies 20≤L*≤37, and

lightness L* of the second skin color display part in the CIE L*a*b* color space satisfies 74≤L*≤81.

### Advantageous Effects

According to the present disclosure, it is possible to provide a skin color chart that enables a more appropriate determination of a face authentication environment and a method for manufacturing the same.

### BRIEF DESCRIPTION OF DRAWINGS

FIG. 1 is a plan view showing a skin color chart according to a first example embodiment;

FIG. 2 is a graph showing an example of a spectral reflectance of a skin color of each of Negroid, Caucasoid, and Mongoloid;

FIG. 3 is a plan view showing a skin color chart according to a second example embodiment;

FIG. 4 is a plan view showing a skin color chart according to a third example embodiment;

FIG. 5 is a plan view showing a skin color chart according to a fourth example embodiment; and

FIG. 6 is a plan view showing a skin color chart according to a fifth example embodiment.

### DESCRIPTION OF EMBODIMENTS

Specific example embodiments will be described hereinafter in detail with reference to the drawings. The same or corresponding elements are denoted by the same reference symbols throughout the drawings, and redundant descriptions will be omitted as necessary for the clarification of the description.

### First Example Embodiment

### <Structure of Skin Color Chart>

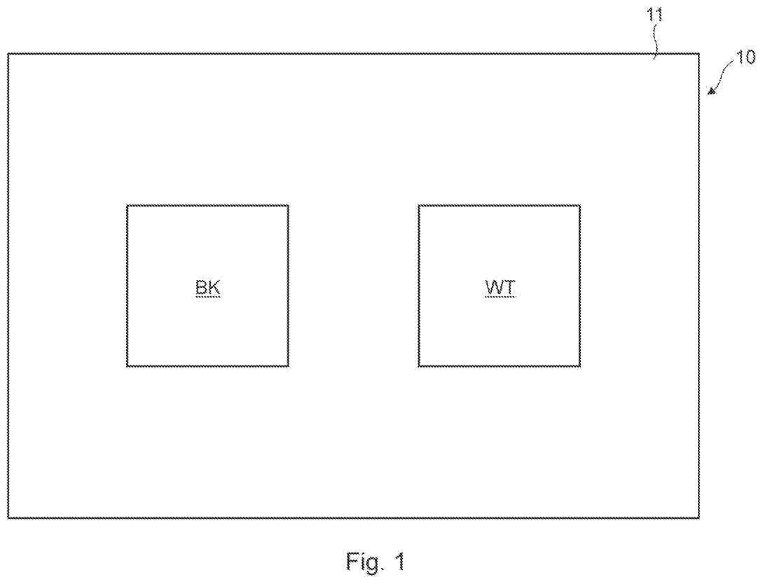

First, a skin color chart according to a first example embodiment will be described with reference to FIG. 1. FIG. 1 is a plan view showing the skin color chart according to the first example embodiment. A skin color chart 10 according to the first example embodiment shown in FIG. 1 is a chart for determining a face authentication environment.

As shown in FIG. 1, the skin color chart 10 according to the first example embodiment includes a substrate 11, a first skin color display part BK, and a second skin color display part WT.

The substrate 11 is made of, for example, cardboard, plastic, wood, metal, glass and combinations thereof, but is not limited to being made of any particular material. When the substrate 11 is made of cardboard, plastic, and wood, it is lightweight and thus can be easily carried. In the example shown in FIG. 1, the substrate 11 has a rectangular planar shape, but is not limited thereto. As an example, the width of the substrate 11 is about 200 mm and the length thereof is about 300 mm, but the size of the substrate 11 is not limited to a particular size. In order to prevent reflection, it is preferable that, for example, the color of the substrate 11 be black having a reflectance of 0, but the color of the substrate 11 is not limited to a particular color.

As shown in FIG. 1, the first skin color display part BK is formed on the substrate 11. The first skin color display part BK shows a skin color near the limit of the distribution of the skin colors of black people on the blackest part of the distribution. Specifically, colors can be defined using a CIE L*a*b* color space standardized by the International Commission on Illumination (CIE) in 1976. Lightness L* of a skin color in the first skin color display part BK expressed in the CIE L*a*b* color space satisfies 20≤L*≤37. An average skin color of Negroid is lighter than the aforementioned skin color and the value of L* is greater than 37. The lightness L* is more preferably 20≤L*≤29.

Further, chromaticity a* and chromaticity b* of the first skin color display part BK satisfy, for example, 8≤a*≤12 and 7≤b*≤10, respectively. The chromaticity a* and the chromaticity b* are more preferably 9≤a*≤11 and 8≤b*≤9, respectively.

Note that, in the example shown in FIG. 1, the first skin color display part BK has a square planar shape, but is not limited thereto.

As shown in FIG. 1, the second skin color display part WT is also formed on the substrate 11. The second skin color display part WT shows a skin color near the limit of the distribution of the skin colors of white people on the whitest part of the distribution. Specifically, lightness L* of a skin color in the second skin color display part WT expressed in the CIE L*a*b* color space satisfies 74≤L*≤81. An average skin color of Caucasoid is darker than the aforementioned skin color and the value of L* is smaller than 74. The lightness L* is more preferably 78≤L*≤81.

Further, chromaticity a* and chromaticity b* of the second skin color display part WT satisfy, for example, 10≤a*≤12 and 23≤b*≤25, respectively. The chromaticity a* and the chromaticity b* are more preferably a*=11 and b*=24, respectively.

Note that, in the example shown in FIG. 1, the first skin color display part BK has a square planar shape, but is not limited thereto.

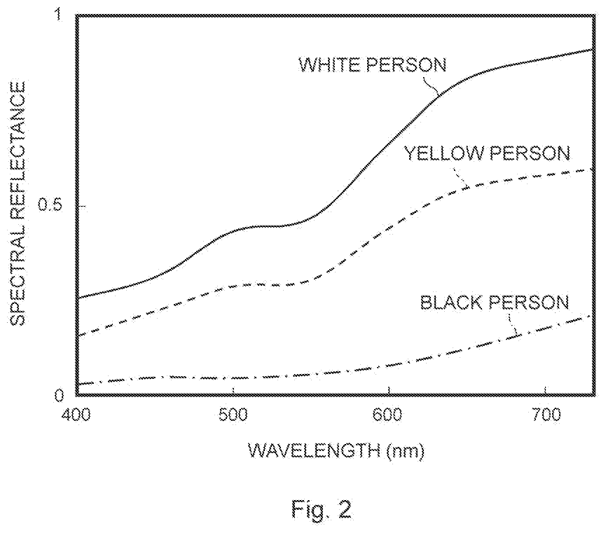

Note that FIG. 2 is a graph showing an example of a spectral reflectance of a skin color of each of Negroid, Caucasoid, and Mongoloid. In FIG. 2, the horizontal axis indicates wavelengths (nm), and the vertical axis indicates the spectral reflectance. As shown in FIG. 2, at each wavelength, the highest spectral reflectance is that of the Caucasoid, the second highest spectral reflectance is that of the Mongoloid, and the lowest spectral reflectance is that of the Negroid. For example, when measurement is performed using a spectrophotometric colorimeter, the values of L*, a*, and b* in the corresponding CIE L*a*b* color space are obtained together with data of a spectral reflectance like the one shown in FIG. 2. A large amount of data of L*, a*, and b* of the skin colors of black and white people are acquired and then a range of the aforementioned values can be determined.

When a face authentication environment is determined using the skin color chart 10, the skin color chart 10 is captured by a camera for face authentication (not shown). Then, in the captured image of the skin color chart 10, it can be determined that the environment is suitable for face authentication if blocked-up shadows do not occur in the first skin color display part BK and blown-out highlights do not occur in the second skin color display part WT.

As described above, in the skin color chart 10 according to this example embodiment, the lightness L* of the skin color in the first skin color display part BK satisfies 20≤L*≤37, and the first skin color display part BK shows the skin color near the limit of the distribution of the skin colors of black people on the blackest part of the distribution. Thus, it is extremely unlikely that a person whose skin is blacker than the first skin color display part BK will be a person on whom face authentication is to be performed. Therefore, in the environment which it has been determined using the skin color chart 10 according to this example embodiment is suitable for face authentication, it is also extremely unlikely that blocked-up shadows will occur in the face image and then face authentication cannot be performed.

On the other hand, the lightness L* of the skin color in the second skin color display part WT satisfies 74≤L*≤81, and the second skin color display part WT shows the skin color near the limit of the distribution of the skin colors of white people on the whitest part of the distribution. Thus, it is extremely unlikely that a person whose skin is whiter than the second skin color display part WT will be a person on whom face authentication is to be performed. Therefore, in the environment which it has been determined using the skin color chart 10 according to this example embodiment is suitable for face authentication, it is also extremely unlikely that blown-out highlights will occur in the face image and then face authentication cannot be performed.

As described above, by using the skin color chart 10 according to this example embodiment, it is possible to more appropriately determine a face authentication environment.

### <Method for Manufacturing Skin Color Chart>

Next, a method for manufacturing a skin color chart according to the first example embodiment will be described with reference to FIG. 1. The first skin color display part BK is formed on the substrate 11 and the second skin color display part WT is formed on the same. One of the first skin color display part BK and the second skin color display part WT may be formed first on the substrate 11, or these two display parts may be formed simultaneously.

Although a specific example of a method for manufacturing a skin color chart according to the first example embodiment will be described below, the method is not limited to this specific example.

First, the first skin color display part BK and the second skin color display part WT prepared in advance are stuck on a mount made of cardboard. For example, paints that have been adjusted to the colors of the first skin color display part BK and the second skin color display part WT are respectively applied to pieces of paper, whereby the first skin color display part BK and the second skin color display part WT can be prepared. The paint is, for example, a non-glossy lacquer paint, but is not limited to a particular paint.

Next, a black cardboard of the same size as that of the mount is prepared, and parts of the black cardboard corresponding to the first skin color display part BK and the second skin color display part WT that have been stuck on the mount are cut out. Then the black cardboard and the mount on which the first skin color display part BK and the second skin color display part WT have been stuck are bonded to each other. Note that the black cardboard has been processed so that the reflectance of the surface thereof becomes 0 (zero).

In this way, the skin color chart 10 can be manufactured. In the skin color chart 10 manufactured according to this specific example, the substrate 11 is formed of a mount and a black cardboard.

As described above, in the skin color chart 10 according to this example embodiment, the first skin color display part BK shows the skin color near the limit of the distribution of the skin colors of black people on the blackest part of the distribution, and the second skin color display part WT shows the skin color near the limit of the distribution of the skin colors of white people on the whitest part of the distribution. Thus, it is extremely unlikely that a person whose skin is blacker than the first skin color display part BK or a person whose skin is whiter than the second skin color display part WT will be a person on whom face authentication is to be performed. Therefore, in the environment which it has been determined using the skin color chart 10 according to this example embodiment is suitable for face authentication, it is also extremely unlikely that blocked-up shadows or blown-out highlights will occur in the face image and then face authentication cannot be performed. That is, by using the skin color chart 10 according to this example embodiment, it is possible to more appropriately determine a face authentication environment.

### Second Example Embodiment

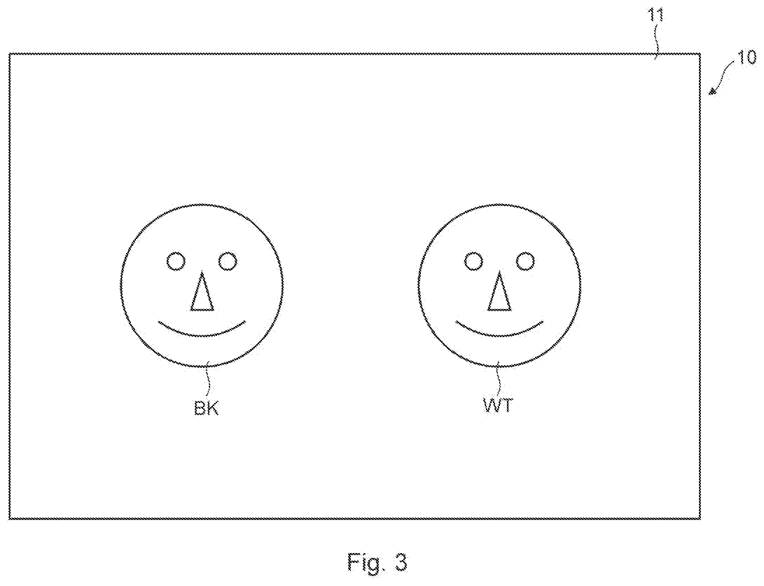

Next, a skin color chart according to a second example embodiment will be described with reference to FIG. 3. FIG. 3 is a plan view showing the skin color chart according to the second example embodiment.

In the skin color chart 10 according to the first example embodiment shown in FIG. 1, each of the first skin color display part BK and the second skin color display part WT is formed in a flat shape (formed so as to be flat). On the other hand, in the skin color chart 10 according to the second example embodiment shown in FIG. 3, each of the first skin color display part BK and the second skin color display part WT is formed in a three-dimensional shape imitating a human face. That is, in each of the first skin color display part BK and the second skin color display part WT, projections and recesses imitating a human face are formed.

In a case in which the skin color chart 10 according to the first example embodiment is used, for example, blocked-up shadows may occur in a recessed part of the face (e.g., a part of the face near the shadow formed by the nose) in the face image of Negroid, and hence there is a possibility that face authentication cannot be performed even in the environment which it has been determined is suitable for face authentication. Alternatively, for example, blown-out highlights may occur in a projection part of the face (e.g., a part of the face near the top of the nose) in the face image of Caucasoid, and hence there is a possibility that face authentication cannot be performed.

On the other hand, in a case in which the skin color chart 10 according to the second example embodiment is used, when a face authentication environment is determined, it is possible to determine that the environment in which blocked-up shadows occur in the recessed part and the like of the first skin color display part BK is not suitable for face authentication. Further, it is possible to determine that the environment in which blown-out highlights occur in the projection part and the like of the second skin color display part WT is also not suitable for face authentication.

Therefore, by using the skin color chart 10 according to this example embodiment, it is possible to further appropriately determine a face authentication environment.

The structures other than the above ones are similar to those of the first example embodiment, and thus the descriptions thereof will be omitted.

### Third Example Embodiment

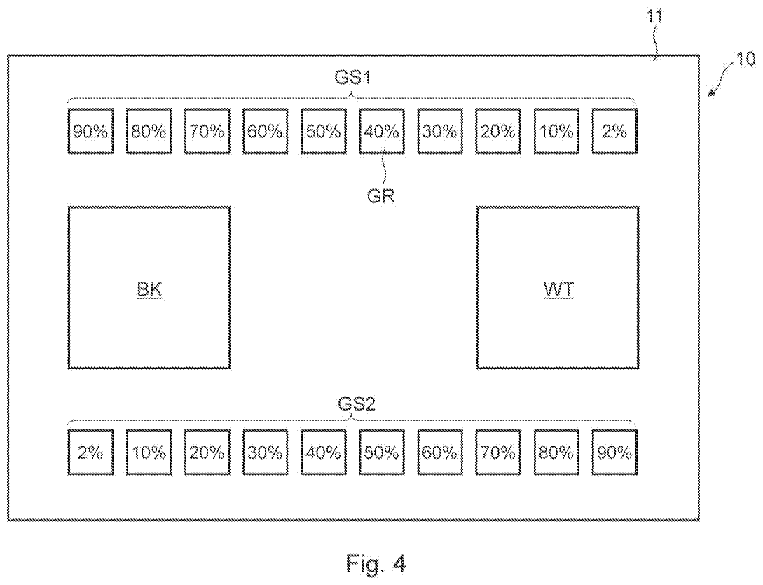

Next, a skin color chart according to a third example embodiment will be described with reference to FIG. 4. FIG. 4 is a plan view showing the skin color chart according to the third example embodiment.

As shown in FIG. 4, the skin color chart 10 according to this example embodiment includes, in addition to the first skin color display part BK and the second skin color display part WT, gray scale parts GS1 and GS2 formed of a plurality of gray display parts GR having different reflectances.

In the example shown in FIG. 4, each of the two gray scale parts GS1 and GS2 includes 10 of the gray display parts GR having reflectances of 2 to 90%. Specifically, the reflectances of the gray display parts GR are 2%, 10%, 20%, 30%, 40%, 50%, 60%, 70%, 80%, and 90%.

In the example shown in FIG. 4, in the gray scale parts GS1 and GS2, the 10 gray display parts GR are arranged in a row along the long side of the rectangular skin color chart 10. Further, the gray scale parts GS1 and GS2 are disposed so as to be opposed to each other with the first skin color display part BK and the second skin color display part WT interposed therebetween.

By using the gray scale parts GS1 and GS2, it is possible, for example, to evaluate the dynamic range of the camera for face authentication (not shown) and adjust it.

Note that, in the example shown in FIG. 4, each of the gray display parts GR has a square planar shape, but is not limited thereto. Further, the number of gray display parts GR included in the gray scale parts GS1 and GS2 and the reflectance of each of the gray display parts GR may be determined as appropriate. Further, the number of gray scale parts may be one.

The structures other than the above ones are similar to those of the first example embodiment, and thus the descriptions thereof will be omitted. The second example embodiment may be combined with the third example embodiment.

### Fourth Example Embodiment

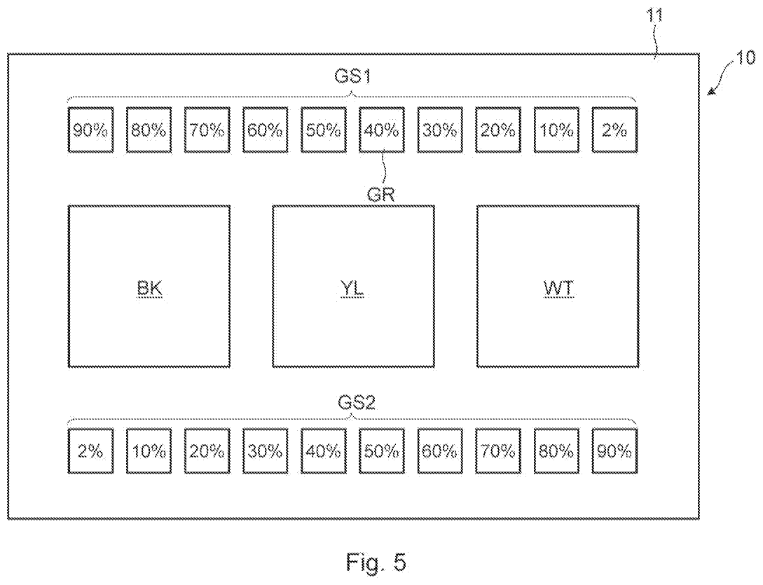

Next, a skin color chart according to a fourth example embodiment will be described with reference to FIG. 5. FIG. 5 is a plan view showing the skin color chart according to the fourth example embodiment.

As shown in FIG. 5, the skin color chart 10 according to this example embodiment includes a third skin color display part YL in addition to the skin color chart 10 according to the third example embodiment.

As shown in FIG. 5, the third skin color display part YL, like the first skin color display part BK and the second skin color display part WT, is formed on the substrate 11. The position where the third skin color display part YL is disposed is not limited to a particular position; in the example shown in FIG. 5, the third skin color display part YL is disposed between the first skin color display part BK and the second skin color display part WT.

The third skin color display part YL shows a skin color between the skin color in the first skin color display part BK and the skin color in the second skin color display part WT. The third skin color display part YL shows, for example, an average skin color of Mongoloid. Specifically, lightness L* of a skin color in the third skin color display part YL expressed in the CIE L*a*b* color space satisfies, for example, 62≤L*≤68. Further, chromaticity a* and chromaticity b* of the third skin color display part YL satisfy, for example, a*=11 and 18≤b*≤19, respectively.

By providing the third skin color display part YL, when a face authentication environment is being determined, it is possible to evaluate the environment in more detail than it is in the cases of the first to the third example embodiments. Specifically, it can be understood that the environment in which blocked-up shadows occur in the third skin color display part YL in addition to the first skin color display part BK is blacker than the environment in which blocked-up shadows occur only in the first skin color display part BK. It can also be understood that the environment in which blown-out highlights occur in the third skin color display part YL in addition to the second skin color display part WT is brighter than the environment in which blown-out highlights occur only in the second skin color display part WT. Based on the above-described evaluations, for example, the position where a camera is installed, the orientation of the camera, and the brightness of a place where a face image is captured can be easily adjusted.

Note that, in the example shown in FIG. 5, the third skin color display part YL has a square planar shape, but is not limited thereto.

The structures other than the above ones are similar to those of the third example embodiment, and thus the descriptions thereof will be omitted. The second example embodiment may be combined with the fourth example embodiment. Further, in the fourth example embodiment, the gray scale parts GS1 and GS2 may not be formed. That is, a structure in which the third skin color display part YL is added to the skin color chart 10 according to the first example embodiment may be employed.

### Fifth Example Embodiment

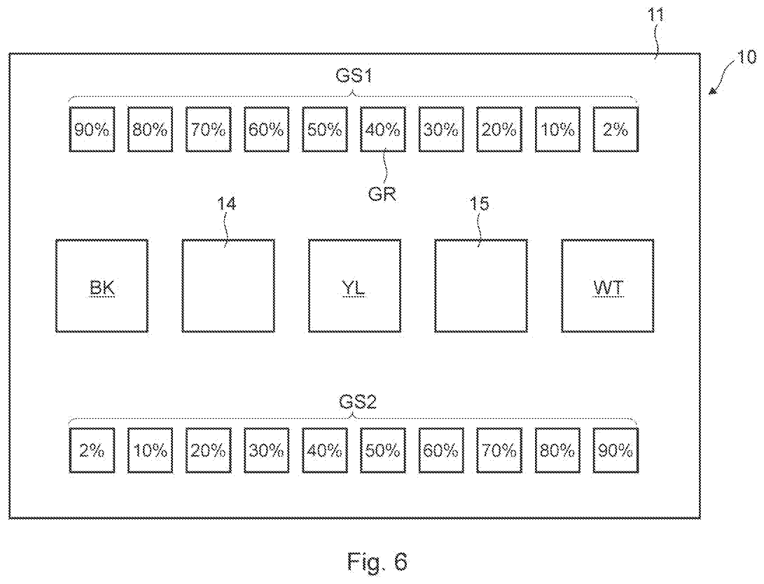

Next, a skin color chart according to a fifth example embodiment will be described with reference to FIG. 6. FIG. 6 is a plan view showing the skin color chart according to the fifth example embodiment.

As shown in FIG. 6, the skin color chart 10 according to this example embodiment includes a fourth skin color display part 14 and a fifth skin color display part 15 in addition to the skin color chart 10 according to the fourth example embodiment.

As shown in FIG. 6, the fourth skin color display part 14 and the fifth skin color display part 15 are also formed on the substrate 11. The position where the fourth skin color display part 14 is disposed and the position where the fifth skin color display part 15 is disposed are not limited to particular positions; in the example shown in FIG. 6, the fourth skin color display part 14 is disposed between the first skin color display part BK and the third skin color display part YL. Further, the fifth skin color display part 15 is disposed between the second skin color display part WT and the third skin color display part YL.

The fourth skin color display part 14 shows a skin color between the skin color in the first skin color display part BK and the skin color in the third skin color display part YL.

The fifth skin color display part 15 shows a skin color between the skin color in the second skin color display part WT and the skin color in the third skin color display part YL.

By providing the fourth skin color display part 14, when a face authentication environment is being determined, the environment can be evaluated in much more detail than it is in the case of the fourth example embodiment. Specifically, it is possible to distinguish the environment in which blocked-up shadows occur in the first skin color display part BK and the fourth skin color display part 14 from the environment in which blocked-up shadows occur only in the first skin color display part BK. Further, it is possible to distinguish the environment in which blocked-up shadows occur in the first skin color display part BK, the fourth skin color display part 14, and the third skin color display part YL from the environment in which blocked-up shadows occur only in the first skin color display part BK and the fourth skin color display part 14.

Similarly, by providing the fifth skin color display part 15, when a face authentication environment is being determined, the environment can be evaluated in much more detail than it is in the case of the fourth example embodiment. Specifically, it is possible to distinguish the environment in which blown-out highlights occur in the second skin color display part WT and the fifth skin color display part 15 from the environment in which blown-out highlights occur only in the second skin color display part WT. Further, it is possible to distinguish the environment in which blown-out highlights occur in the second skin color display part WT, the fifth skin color display part 15, and the third skin color display part YL from the environment in which blown-out highlights occur only in the second skin color display part WT and the fifth skin color display part 15.

Based on the above-described evaluations, for example, the position where a camera is installed, the orientation of the camera, and the brightness of a place where a face image is captured can be more easily adjusted.

Note that, in the example shown in FIG. 6, each of the fourth skin color display part 14 and the fifth skin color display part 15 has a square planar shape, but is not limited thereto. Further, the skin color chart 10 may include only one of the fourth skin color display part 14 and the fifth skin color display part 15.

Further, a plurality of fourth skin color display parts 14 showing skin colors different from each other may be provided in the skin color chart 10. Similarly, a plurality of fifth skin color display parts 15 showing skin colors different from each other may be provided in the skin color chart 10.

Further, in this example embodiment, the skin colors of the third skin color display part YL, the fourth skin color display part 14, and the fifth skin color display part 15 may show, for example, average skin colors in specific countries or regions.

The structures other than the above ones are similar to those of the fourth example embodiment, and thus the descriptions thereof will be omitted. The second example embodiment may be combined with the fifth example embodiment. Further, in the fifth example embodiment, the gray scale parts GS1 and GS2 may not be formed. That is, a structure in which the third skin color display part YL, the fourth skin color display part 14, and the fifth skin color display part 15 are added to the skin color chart 10 according to the first example embodiment may be employed.

Although the present disclosure has been described with reference to the example embodiments, the present disclosure is not limited to the above-described example embodiments. Various changes that may be understood by those skilled in the art may be made to the configurations and details of the present disclosure within the scope of the disclosure.

The whole or part of the example embodiments disclosed above can be described as, but not limited to, the following supplementary notes.

### (Supplementary Note 1)

A skin color chart for determining an environment where face authentication is performed, the skin color chart comprising:

a substrate;

a first skin color display part configured to show a skin color of a Negroid, the first skin color display part being formed on the substrate; and

a second skin color display part configured to show a skin color of a Caucasoid, the second skin color display part being formed on the substrate, wherein

lightness L* of the first skin color display part in a CIE L*a*b* color space satisfies 20≤L*≤37, and

lightness L* of the second skin color display part in the CIE L*a*b* color space satisfies 74≤L*≤81.

### (Supplementary Note 2)

The skin color chart according to Supplementary note 1, wherein each of the first and the second skin color display parts is formed in a three-dimensional shape imitating a human face.

### (Supplementary Note 3)

The skin color chart according to Supplementary note 1 or 2, further comprising a plurality of gray display parts having different reflectances, the gray display parts being formed on the substrate.

### (Supplementary Note 4)

The skin color chart according to any one of Supplementary notes 1 to 3, further comprising a third skin color display part configured to show a skin color between the skin color in the first skin color display part and the skin color in the second skin color display part, the third skin color display part being formed on the substrate,

wherein lightness L* of the third skin color display part in the CIE L*a*b* color space satisfies 62≤L*≤68.

### (Supplementary Note 5)

The skin color chart according to Supplementary note 4, further comprising, on the substrate, at least one of:

a fourth skin color display part configured to show a skin color between the skin color in the first skin color display part and the skin color in the third skin color display part; and

a fifth skin color display part configured to show a skin color between the skin color in the second skin color display part and the skin color in the third skin color display part.

### (Supplementary Note 6)

The skin color chart according to any one of Supplementary notes 1 to 5, wherein the substrate is black.

### (Supplementary Note 7)

A method for manufacturing a skin color chart for determining an environment where face authentication is performed, the method comprising:

forming, on a substrate, a first skin color display part configured to show a skin color of a Negroid; and

forming, on the substrate, a second skin color display part configured to show a skin color of a Caucasoid, wherein

lightness L* of the first skin color display part in a CIE L*a*b* color space satisfies 20≤L*≤37, and

lightness L* of the second skin color display part in the CIE L*a*b* color space satisfies 74≤L*≤81.

### (Supplementary Note 8)

The method according to Supplementary note 7, wherein each of the first and the second skin color display parts is formed in a three-dimensional shape imitating a human face.

### (Supplementary Note 9)

The method according to Supplementary note 7 or 8, further comprising forming a plurality of gray display parts having different reflectances on the substrate.

### (Supplementary Note 10)

The method according to any one of Supplementary notes 7 to 9, further comprising forming, on the substrate, a third skin color display part configured to show a skin color between the skin color in the first skin color display part and the skin color in the second skin color display part,

wherein lightness L* of the third skin color display part in the CIE L*a*b* color space satisfies 62≤L*≤68.

### (Supplementary Note 11)

The method according to Supplementary note 10, further comprising forming, on the substrate, at least one of:

a fourth skin color display part configured to show a skin color between the skin color in the first skin color display part and the skin color in the third skin color display part; and

a fifth skin color display part configured to show a skin color between the skin color in the second skin color display part and the skin color in the third skin color display part.

### (Supplementary Note 12)

The method according to any one of Supplementary notes 7 to 11, wherein the substrate is black.

### REFERENCE SIGNS LIST

10 SKIN COLOR CHART
11 SUBSTRATE
BK FIRST SKIN COLOR DISPLAY PART
WT SECOND SKIN COLOR DISPLAY PART
YL THIRD SKIN COLOR DISPLAY PART
14 FOURTH SKIN COLOR DISPLAY PART
15 FIFTH SKIN COLOR DISPLAY PART
GR GRAY DISPLAY PART
GS1, GS2 GRAY SCALE PART

What is claimed is:

1. A skin color chart for determining an environment where face authentication is performed, the skin color chart comprising:
a substrate;
a first skin color display part configured to show a skin color of a Negroid, the first skin color display part being formed on the substrate; and
a second skin color display part configured to show a skin color of a Caucasoid, the second skin color display part being formed on the substrate, wherein
lightness L* of the first skin color display part in a CIE L*a*b* color space satisfies 20≤L*≤37, and
lightness L* of the second skin color display part in the CIE L*a*b* color space satisfies 74≤L*≤81.

2. The skin color chart according to claim 1, wherein each of the first and the second skin color display parts is formed in a three-dimensional shape imitating a human face.

3. The skin color chart according to claim 1, further comprising a plurality of gray display parts having different reflectances, the gray display parts being formed on the substrate.

4. The skin color chart according to claim 1, further comprising a third skin color display part configured to show a skin color between the skin color in the first skin color display part and the skin color in the second skin color display part, the third skin color display part being formed on the substrate,
wherein lightness L* of the third skin color display part in the CIE L*a*b* color space satisfies 62≤L*≤68.

5. The skin color chart according to claim 4, further comprising, on the substrate, at least one of:
a fourth skin color display part configured to show a skin color between the skin color in the first skin color display part and the skin color in the third skin color display part; and
a fifth skin color display part configured to show a skin color between the skin color in the second skin color display part and the skin color in the third skin color display part.

6. The skin color chart according to claim 1, wherein the substrate is black.

7. A method for manufacturing a skin color chart for determining an environment where face authentication is performed, the method comprising:
forming, on a substrate, a first skin color display part configured to show a skin color of a Negroid; and
forming, on the substrate, a second skin color display part configured to show a skin color of a Caucasoid, wherein
lightness L* of the first skin color display part in a CIE L*a*b color space satisfies 20≤L*≤37, and
lightness L* of the second skin color display part in the CIE L*a*b* color space satisfies 74≤L*≤81.

8. The method according to claim 7, wherein each of the first and the second skin color display parts is formed in a three-dimensional shape imitating a human face.

9. The method according to claim 7, further comprising forming a plurality of gray display parts having different reflectances on the substrate.

10. The method according to claim 7, further comprising forming, on the substrate, a third skin color display part configured to show a skin color between the skin color in the first skin color display part and the skin color in the second skin color display part,
wherein lightness L* of the third skin color display part in the CIE L*a*b* color space satisfies 62≤L*≤68.

11. The method according to claim 10, further comprising forming, on the substrate, at least one of:
a fourth skin color display part configured to show a skin color between the skin color in the first skin color display part and the skin color in the third skin color display part; and
a fifth skin color display part configured to show a skin color between the skin color in the second skin color display part and the skin color in the third skin color display part.

12. The method according to claim 7, wherein the substrate is black.
